(19) United States
(12) Patent Application Publication
(10) Pub. No.: US 2008/0222417 A1
(43) Pub. Date: Sep. 11, 2008

(54) Method, System, And Apparatus For Nested Security Access/Authentication With Media Initiation

(76) Inventors: James Downes, Rochester Hills, MI (US); Filip Szalewicz, Macomb, MI (US)

Correspondence Address: CHADBOURNE & PARKE LLP, 30 ROCKEFELLER PLAZA, NEW YORK, NY, 10112, US

(21) Appl. No.: 11/744,129

(22) Filed: May 3, 2007

Related U.S. Application Data
(63) Continuation-in-part of application No. 11/682,751, filed on Mar. 6, 2007.

(51) Int. Cl. H04L 9/32

(52) U.S. Cl. 713/172; 726/7

(57) ABSTRACT

The disclosure details a nested security access system that manages access points/verification requests to create a series of layered security applications for securing access/user identification data. The NSA system works in coordination with an access point/verification module to generate a series of instructions as a login/verification module that may be executed locally. The login/verification module is executed by the access point/verification module to create a system user access/verification data entry form. Depending on the implementation, the access point/verification module may be configured to accept typed text or clicked image access/verification data, token access/verification data or selected image sequence access/verification data. The process of selected image sequence access involves the system user selecting a series of images that represent individual elements of a password without having to type the information into a data entry form.

This application is a continuation in part of and claims priority under 35 U.S.C. §120 to U.S. application Ser. No. 11/682,751, filed Mar. 6, 2007 and titled “METHOD, SYSTEM AND APPARATUS FOR NESTED SECURITY ACCESS/AUTHENTICATION” and to U.S. Provisional Patent Application No. 60/746,350 entitled, “METHOD, SYSTEM, AND APPARATUS FOR NESTED SECURITY ACCESS/AUTHENTICATION WITH MEDIA INITIATION,” filed on May 3, 2006, under 35 U.S.C. §119, both which are incorporated in their entirety herein by reference.

### FIELD OF THE INVENTION

The present invention is directed generally to apparatuses, methods, and systems for securing data and more particularly, to an apparatus, method and system facilitating secure data by providing a series of nested security measures to combat various computer data hacking techniques.

### BACKGROUND OF THE INVENTION

One of the internet's greatest advantages—enabling easy access to data across a multitude of access points/web portals—also raises a series of significant security issues. More specifically, security challenges involve attempting to secure data, for example ensuring that only certain individuals can navigate beyond an access point. Additional challenges include verifying/authenticating that the certain individuals have the necessary permissions to access the data.

One conventional method of attempting to secure data access involves requiring a user to input a password before allowing the user to access certain data on the internet. However, automated computer programs have been developed that reside on a user's computer and covertly collect a user's passwords. Periodically, the automated program transmits the user's passwords back to the distributor of the malicious program. In order to counteract malicious software, developers have created two conventional methods for frustrating automated spyware computer programs. A first security solution developed for data access/entry applications involves static image verification, whereas a second involves static password selection and entry.

In one implementation, the static image verification involves a central server transmitting an image to a data access point. The image often includes measures designed to frustrate automated computer programs implementing optical character recognition modules from automatically accessing the data. For example, a web surfer attempts to get music concert tickets. In order to ensure that no one internet user can automatically access and reserve a significant number of tickets, the ticket distributor transmits a static image to the user's web browser. The static image includes a text-based password, however the text in the image is skewed. The program ensures that an individual will able to discern the text within the static image and enter the text into a text box to proceed.

Another conventional data access/entry security measure involves static image password selection and entry. This security measure has been created to defeat certain computer programs that reside on computer and log record user information, including data associated with a user's keystrokes and/or user mouse clicks. For example, a user attempts to access their financial data. The financial data host may ask for a username and/or pin information, before allowing access. Instead of typing the pin information into a data entry point, the financial data host may present the user with an image of a numerical keypad. The user can type in the username and click on the numerical image buttons displayed as the keypad that correspond to their pin number. However, clicking on the numerical image buttons, simply fills a text box with the text corresponding to the user's pin information.

However, both of these conventional data access/entry security modules are still susceptible to being compromised, thereby exposing confidential passwords/pin data/user authentication data, as well as supposedly ‘secure data’ across the internet.

### SUMMARY OF THE INVENTION

The disclosure details the implementation of apparatuses, methods, and systems directed to robust nested security measures. An object of the invention involves providing a tool that authenticates/verifies an end user's personal identification data (e.g., passwords, pin), in order to protect the user's identifying information, and secure data accessible via the internet. According to an implementation of the invention, a method for facilitating nested security measures includes three primary elements that work in coordination to secure data. In an implementation, three security elements include: 1.) a dynamic image login generation; 2.) clickable data entry; and 3.) dynamic login verification. In another embodiment of the invention, a media initiated application may be implemented as a fourth security element either as a stand-alone security element or in combination with other security elements.

### BRIEF DESCRIPTION OF THE DRAWINGS

The accompanying drawings illustrate various non-limiting, example, inventive aspects in accordance with the present disclosure:

FIG. 1 of the present disclosure is a high-level diagram illustrating the entities that interact with the system according to an embodiment of the invention for facilitating nested secure access/authentication (NSA);

FIGS. 2A and 2B of the present disclosure illustrate a high-level flow diagrams illustrating an process flow associated with security elements implemented as a nested secure access system, according to an embodiment of the invention;

FIGS. 3A-3C of the present disclosure illustrate a flow diagrams associated three implementations of the nested secure access system according to various embodiments of the invention;

FIG. 4 of the present disclosure illustrates a flow diagram associated with a process that generates nested security elements according to an embodiment of the invention;

FIGS. 5A-5J illustrate aspects of six possible implementations of nested user access security elements of the present disclosure;

FIGS. 5K-5L illustrate implementations of a secure user login associated with the flow diagram illustrated in FIG. 3B.

FIG. 6 is a flow diagram illustrating aspects of the access data verification process associated with an embodiment of the invention;

FIG. 7 illustrates inventive software module/hardware components of a NSA controller in a block diagram, according to an embodiment of the invention; and

An Appendix is attached to the document describing various embodiments of security elements associated with the invention.

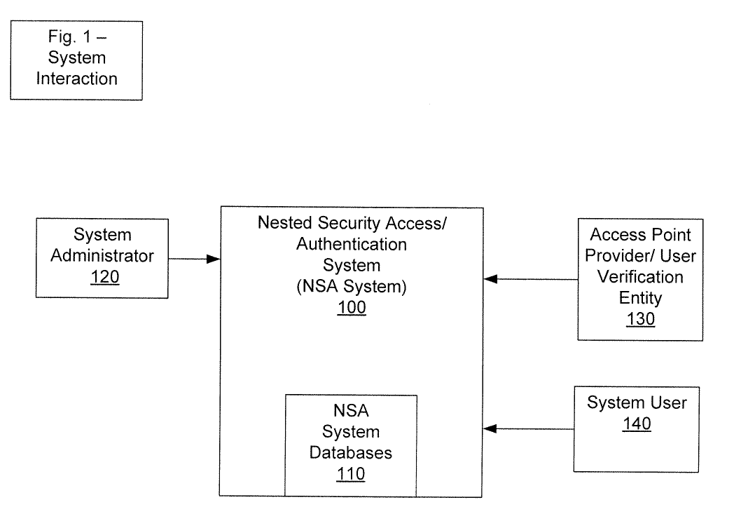

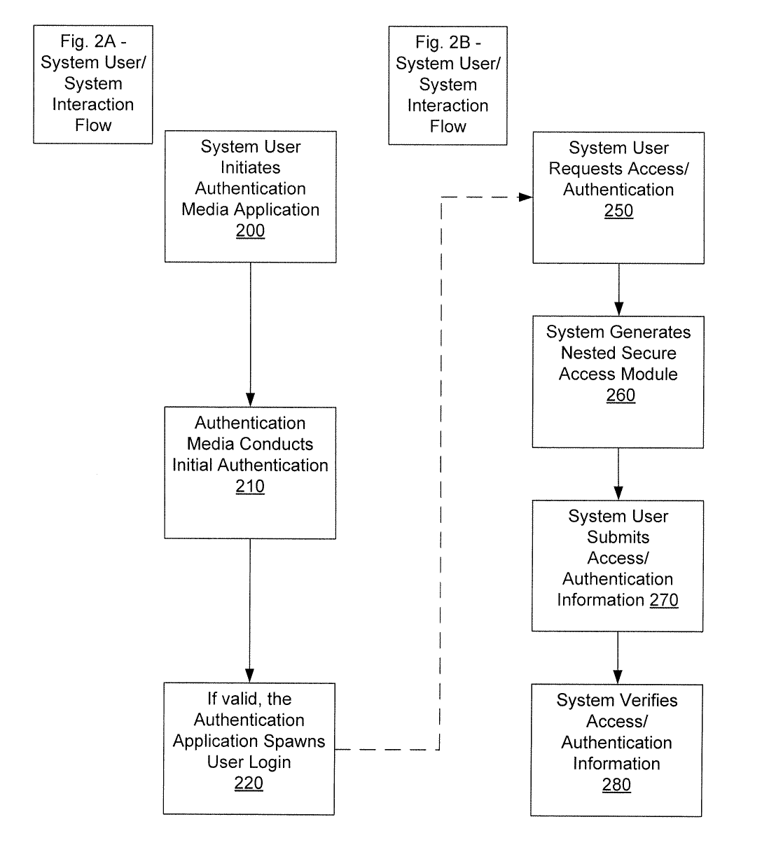

The leading number of each reference number within the drawings indicates the figure in which that reference number is introduced and/or detailed. As such, reference number 101 is first introduced in FIG. 1. Reference number 201 is introduced in FIG. 2, etc.

### DETAILED DESCRIPTION

In order to address the issues discussed above, the invention is directed to systems, methods and apparatuses configured to facilitate nested security modules. It is to be understood that depending on the particular needs and/or characteristics of an access point or system user, various embodiments of the system may be implemented that enable a great deal of flexibility and customization. The instant disclosure discusses an embodiment of the system within the context of accessing data online, as well as verifying/authenticating a system's user's identifying information. However, it is to be understood that the system described herein may be readily configured/customized to provide nested security access (NSA) for a wide range of applications or implementations. For example, aspects of the data access NSA system may be adapted for use in protecting an individual's identification data, such as data submitted as part of a credit card purchase. In another example, aspects of the data access NSA system may be adapted for use in protecting and/or securing access to a variety of multi-user and/or embedded systems, such as ATMs or password-protected portable devices. It is to be understood that the NSA system may be further adapted to include additional data/transaction security elements.

FIG. 1 illustrates a high-level diagram of the entities that interact with the system according to an embodiment of the invention. By way of example only, an implementation includes a core NSA systemization 100 and NSA system databases 110. System administrators 120 may configure and maintain the system 100 and various system databases 110. For illustrative purposes, the implementation illustrated in FIG. 1 is directed to provide nested security access for a web-enabled access point. However, the NSA system may be configured to facilitate additional or different nested security elements based on an end user's particular security needs. For example, additional nested security modules may include security elements that facilitate additional aspects of user identification authentication/verification, for example asking a user a personalized question. Furthermore, the system may be adapted to facilitate secure transactions, or provide secure access management for a variety of multi-user or embedded systems.

The NSA system is configured to protect data associated with the access point provider 130, the system user 140 attempting to gain access to the access point, as well as the data beyond the access point. For example, an access point provider 130 may be a financial institution that provides web-enabled access for individuals (system users) that maintain financial accounts with the institution. The financial institution is able to use the system to help verify a system user's identify. Alternate implementations include protecting/authenticating a system user's identification/transaction data as part of a online monetary transaction, restricting use of a portable device, restricting access to money from an ATM, and/or the like. In those alternate examples, the role of the Access Point provider 130 may be considered synonymous with an user identification verification entity.

FIG. 1 illustrates the system 100 and system administrator 120 as separate elements of the implementation. However, as discussed above, the invention facilitates a great deal of flexibility and scalability. Therefore, it is to be understood that the functionality described below may be incorporated into the access point provider's system 130 (e.g., the financial institution's online account access system) or remotely executed by an authentication entity. Accordingly, in some implementations, the system administrator 120 and/or the access point provider 130 may be associated with the same entity.

At a high level, the system facilitates nested security access module generation; nested security access/authentication data submission; and nested security access/authentication submitted data verification. In some implementations, the system may be configured with additional security elements that protect access to other security elements by acting as a doorkeeper. This particular implementation is illustrated in FIGS. 2A and 2B and represented by the dashed line connecting elements 240 and 250. In an implementation, the secure access procedure starts with element 250 (with a system user requesting access/authentication) and nested secure access procedure incorporates the elements illustrated in FIG. 2B. However, in some implementations a first security element is implemented as a media application initiation security element 200 and incorporates additional security processes, for example the steps shown in FIG. 2A.

In step 200, the system user initiates an authentication media application. It is to be understood that the actual type of media may vary based on the individual needs and capabilities of a system user. For example, a media initiation device with the initiation application may be any type of device capable of storing an application, such as a compact disc, DVD, floppy or zip disk/drive, a thumb drive, flash memory device, RFID or biometric cards, magnetic stripe cards, removable and/or internal hard drives, and/or the like.

In an alternative implementation, an authentication media application may be downloaded and/or otherwise installed to a user's computer (e.g., stored on the computer's hard drive) and initiated as needed for authentication. In yet other implementations, the application may be configured and stored on any number of devices including wireless enabled PDAs, cell phones, personal media players, remote controls, or any other number electronic devices that may or may not have wireless data transfer capabilities. In some implementations employing portable electronic devices, a further security measure may be instituted whereby a user must enter authenticating information, such as a code or password, on the portable device in order for it to transmit application data. For illustrative purposes, the media initiation device will be discussed in the context of a compact disc storage disc that a user may insert into a computer's compact disc (CD) drive.

In step 200, the system user initiates the authentication media by placing the CD into a CD drive. In some implementations, the CD includes an application that conducts an initial authentication process in step 210. The initial authentication process may, for example, comprise a search for an authenticating data element on the user's computer, such as a cookie, file installed to the computer during CD registration, and/or the like. Alternately, the application may proceed right into step 220 and spawn a user login application. The process may subsequently transition into the security elements described in FIG. 2B.

FIG. 2B of the present disclosure illustrates a high-level flow diagram of three core aspects of system/system user/access point (verification entity) interaction, according to an embodiment of the invention configured to achieve these objectives. As illustrated in FIG. 2B, step 250 involves a system user requesting access (or requesting system user identification authentication) to an access point (or for an online transaction) with nested secure access/authentication elements.

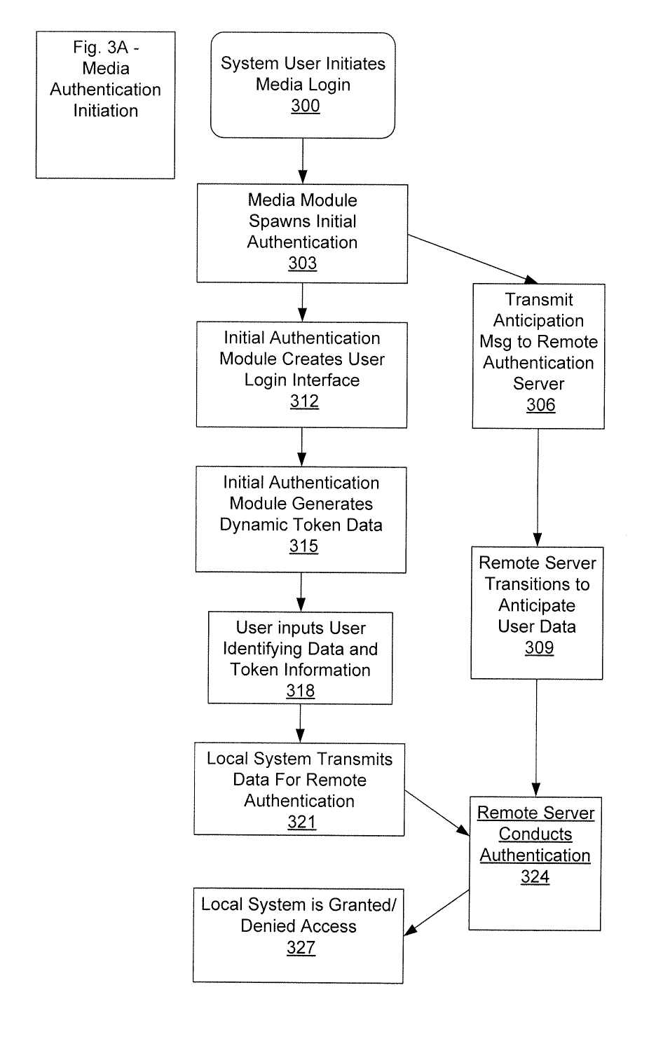

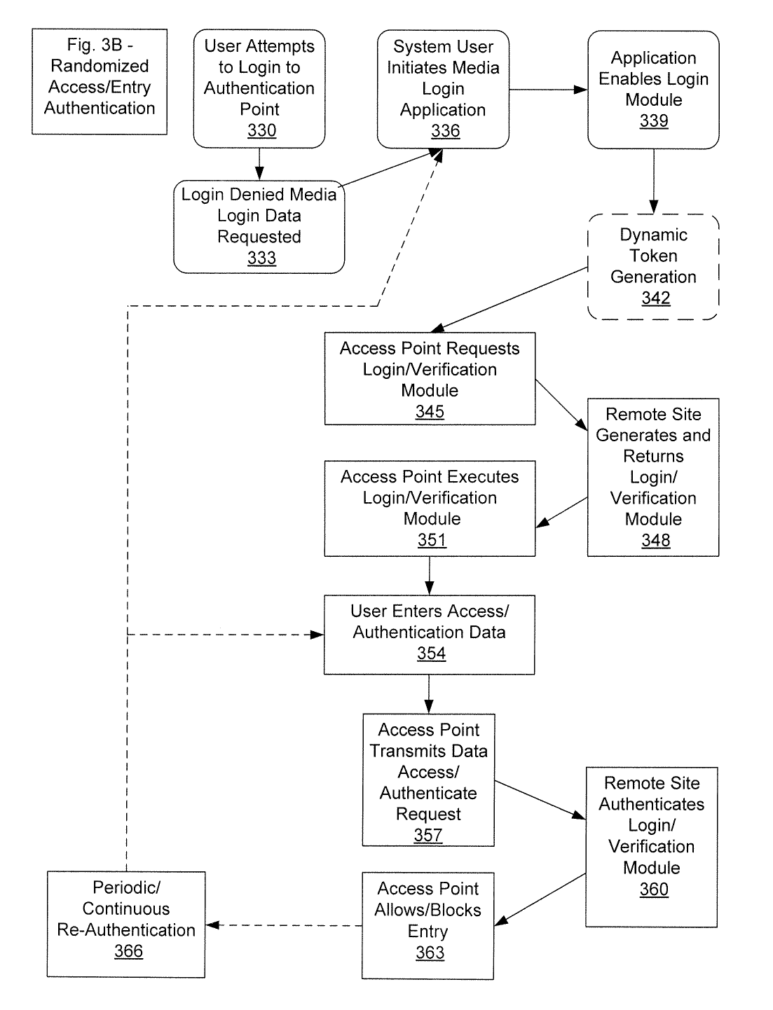

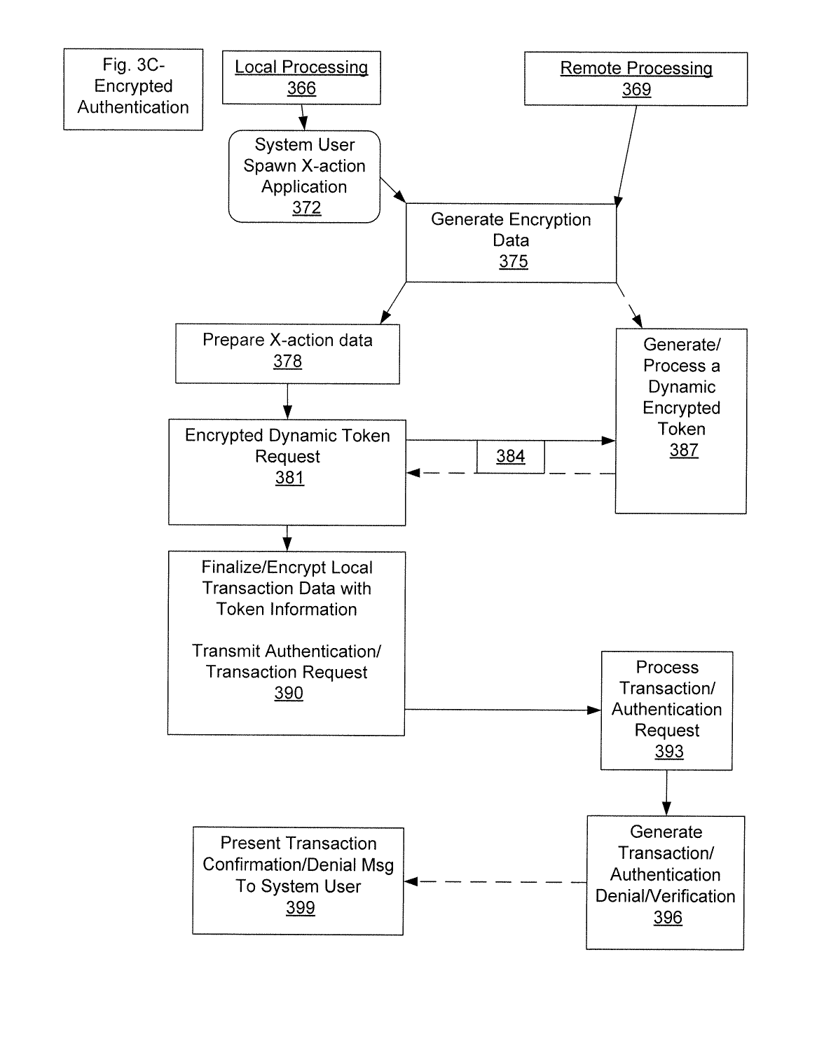

The next step in the process involves generating a nested secure access module in step 260. The nested secure access module is, in one implementation, another security element that is nested within the overall process and protects both the data maintained beyond the access point and/or the access data associated with system user (in some implementations the element may be configured to authenticate a system user). Accordingly, in step 260 the system user inputs access/authentication data (this process will be described in greater detail in FIGS. 3A-3C). The input data may be encapsulated or encrypted depending on the implementation before it is transferred to the system verification module in step 270. If the input access/authentication data is verified, the system may generate an authentication indicator that facilitates access to designated portions of a database, entry to an online access point accessible to the particular system user, access to the use of an embedded system and/or portable device, facilitate an online transaction and provide the verification (or access denial) message to a system user, and/or the like in step 280.

FIGS. 3A-3C illustrate flow diagrams associated with three respective implementations of NSA systems with a media initiated authentication. FIG. 3A is a flow diagram describing an implementation of media initiated authentication. The process is started when a system user initiates media login, such as by inserting a compact disc into a computer, in step 300. In an implementation, the disc stores an application that starts up and conducts an initial authentication (e.g., looks for a cookie or other data key downloaded to the system when the user registered the disc). Other implementations may omit this step and go directly to the spawning an initial authentication interface 303.

Further, the application may be configured to automatically generate the initial authentication interface 312. In the alternative, the media application may be initiated after a user attempts to access a user access/authentication point. For example, a user types in a web address into a browser and is unable to access the login interface. As the web page is loading, a program module may be configured to determine if the media application is stored in a media device that is currently accessible. If the media application is not accessible, the user may be prompted to make the program accessible (e.g., by inserting the compact disc or initiating the application on a wireless device).

In certain configurations, the media application may be configured to transmit an alert message along with an identifier signaling to a remote server that a user may be attempting to login in step 306. In step 309, the remote server may be configured to start a watchdog process determining whether a viable login attempt was received and correlated to the identifier within a designated period of time after receiving the initial alert message. In one implementation, the remote server may only grant user access and/or verification if a user authentication process is successfully completed within a prescribed time interval after initiation of the watchdog process. In the event that a certain amount of time passes before a viable login is established, the remote server may be configured to undertake certain security measures, such as sending an email to a user to determine if they need assistance or possibly applying a temporary freeze on account access. The remote server may also monitor whether multiple unsuccessful login attempts are undertaken and, if so, notifying the user and/or applying a temporary freeze on account access. In an implementation wherein the media application is configured on an internet-capable wireless device, the remote server may directly send an authentication signal and/or notification to the device to establish whether it is being employed for authentication.

In addition to generating the user login interface in step 312, the media application may be configured to generate a token for use during the login process in step 315. The generated token may be configured as time-sensitive and expire after a certain period of time. In step 318, the system user then inputs identifying information, such as a user id, a password, a PIN, and/or the like, and in some implementations the token data generated in step 315. The local system then transmits the data for remote authentication in step 321. The remote system receives the identifying information and token data (and disables the watchdog process if it was initiated) and conducts the authentication in step 324. Also in step 324, the system generates and transmits an authentication confirmation/denial message, which may be displayed to the system user in step 327. In an implementation wherein the media application is stored on a portable device having a display screen and wireless data access, the system transmitted authentication confirmation/denial message may be sent to that portable device.

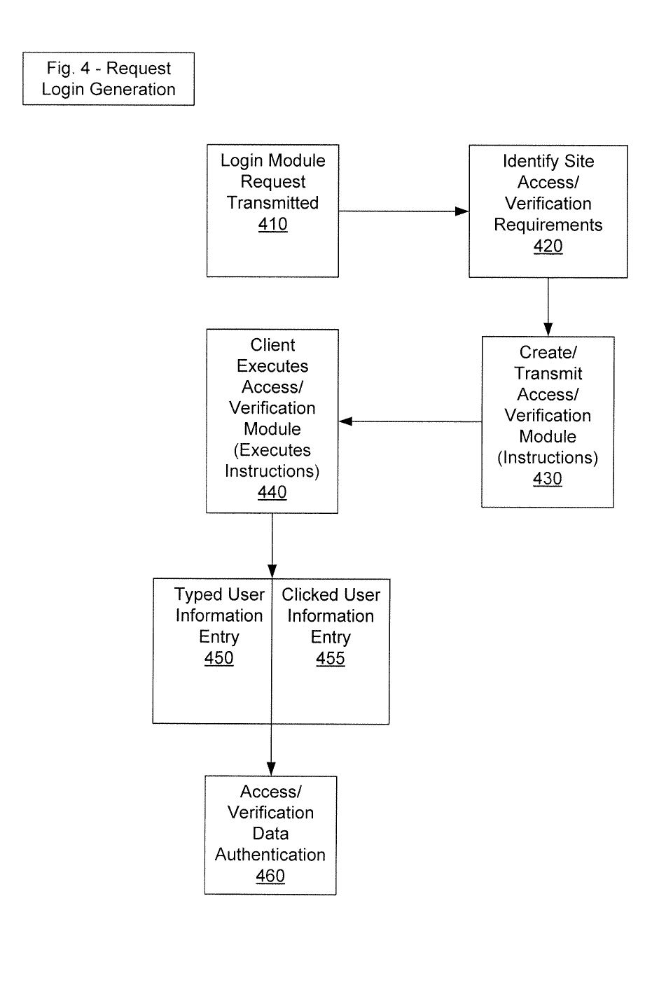

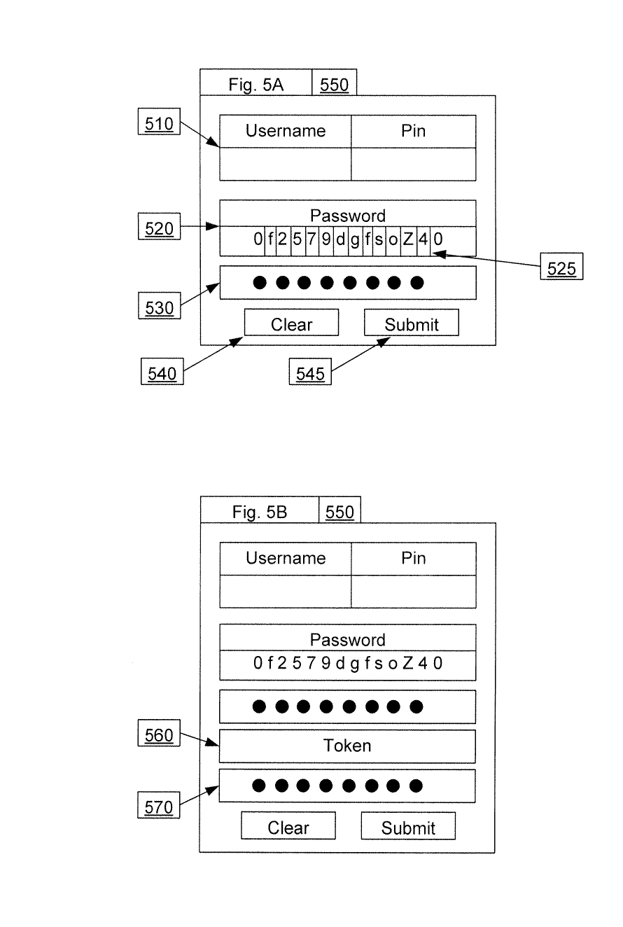

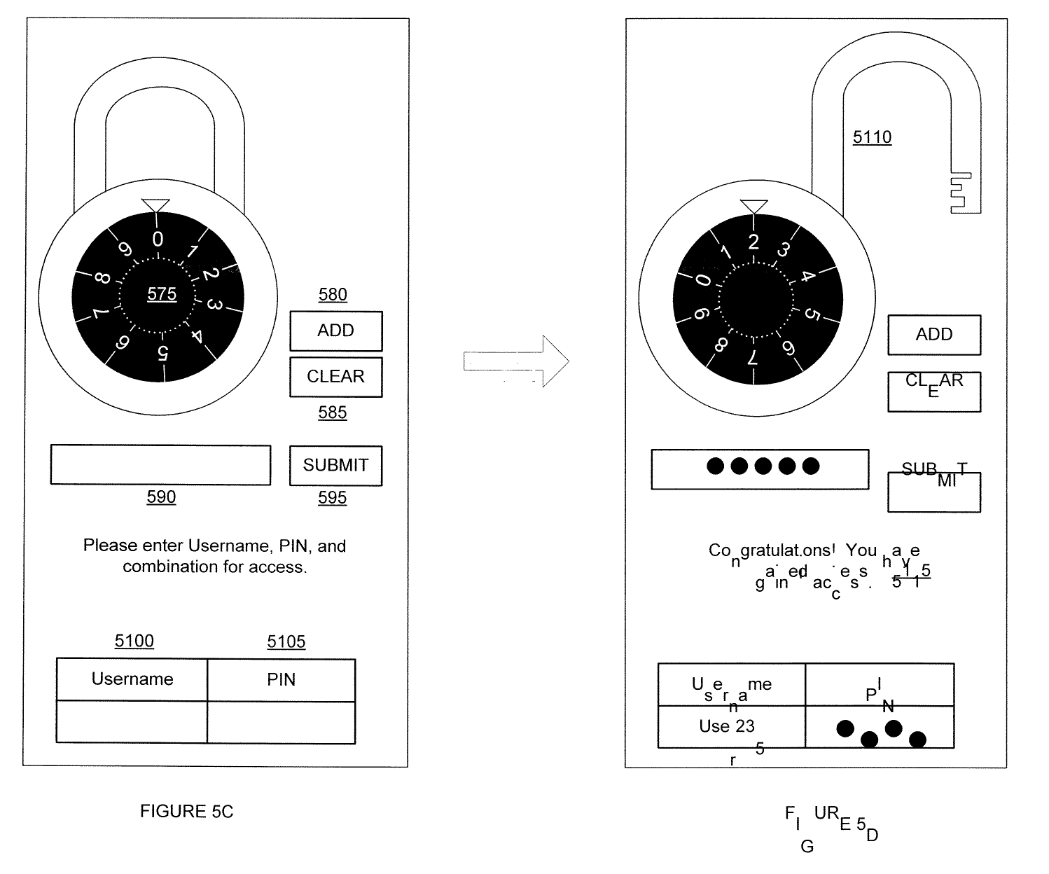

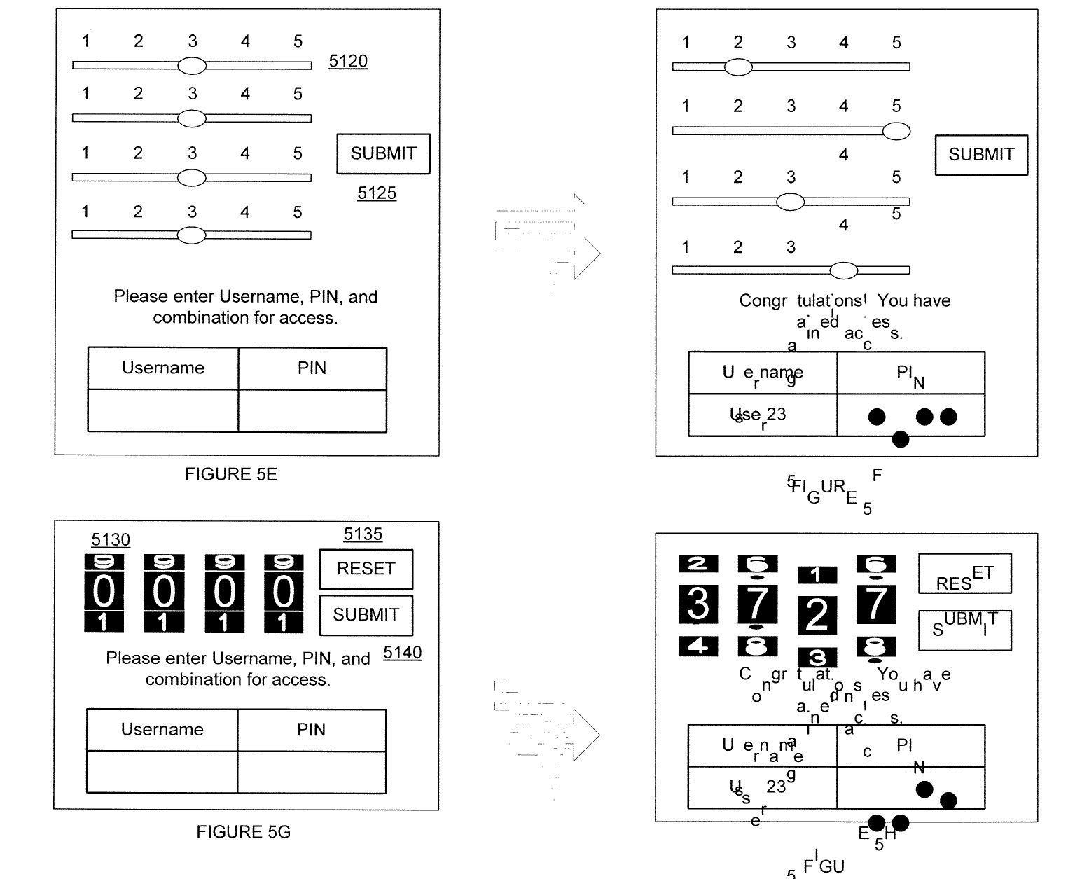

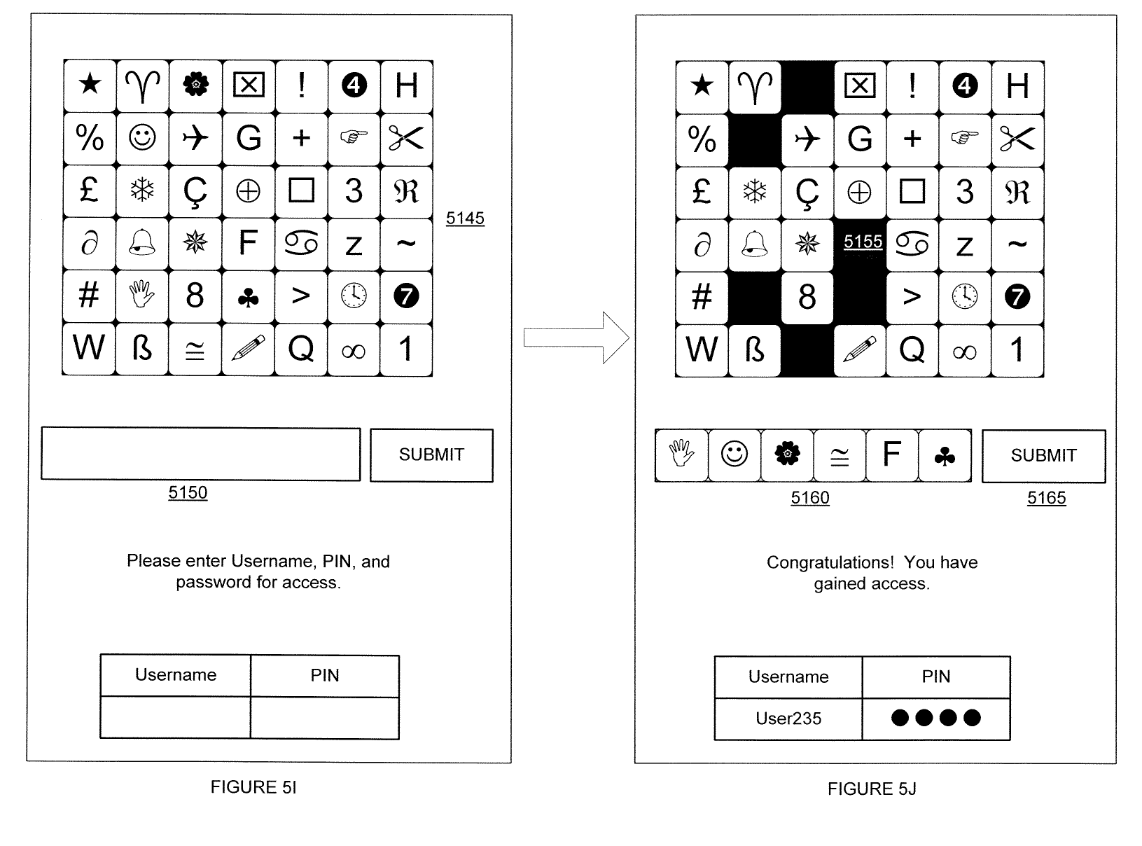

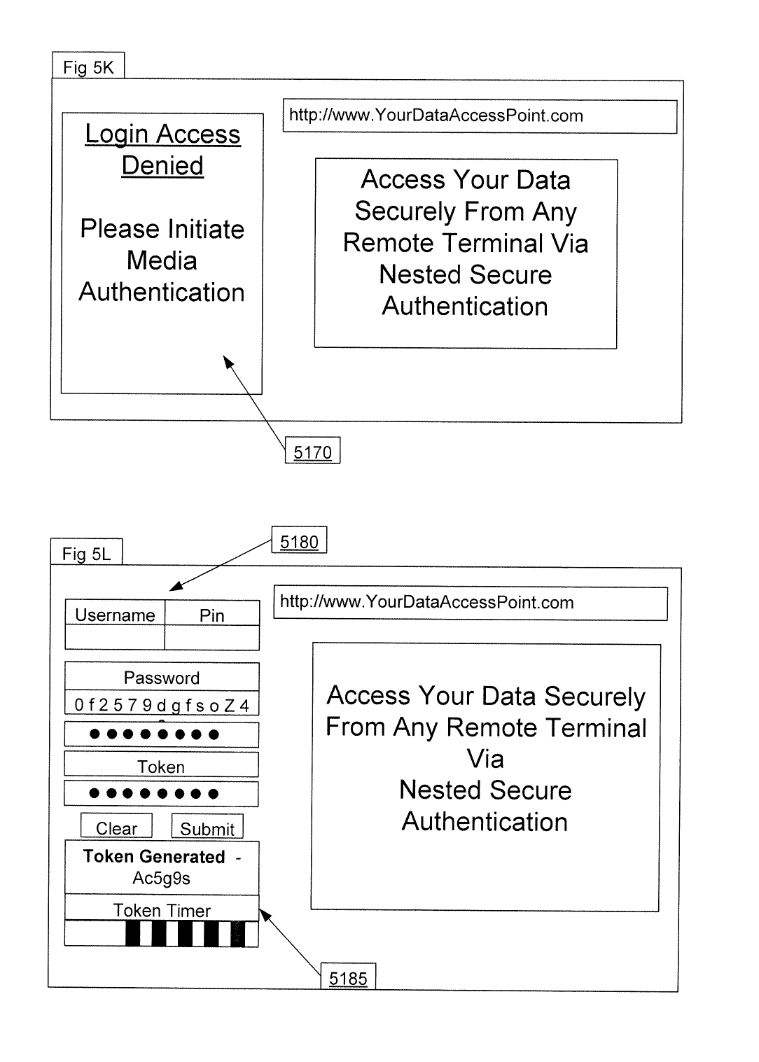

FIG. 3B is a flow diagram describing another implementation of the initial media authentication process (example screen diagrams associated with this process are included as FIGS. 5K and 5L). In step 330, the system user attempts to navigate to an authentication point (e.g., a user login screen associated with a financial institution). However, as the web page is downloading, a program module determines that the media initiated login application is not currently accessible in step 333. For example, the program module may automatically query an access point for a media identification code indicating the presence of the proper media and/or other authentication codes, files, passwords, and/or the like that are associated with the presence of the media application. Therefore, if the media identification code is not found, a “Login denied” message (similar to the one displayed as FIG. 5K) is generated and displayed in the area of the web page where the user login data entry interface is generally located.

The system user inserts the compact disc with the media application into the computer and attempts to reload the web page in step 336. In one implementation, the user manually reloads the web page while, in another implementation, the web page automatically reloads upon insertion, execution, and/or recognition of the media and/or media application depending on the particular implementation. The system determines that the media application is now accessible and enables the login request module in step 339. Some implementations of the system include dynamic token generation functionality 342 as described above. At this point the system user's terminal proceeds to the next in the series of secure elements associated with the nested secure access generation/authentication process (e.g., such as those illustrated in FIG. 2B).

According to the embodiment illustrated in FIG. 3B, the system user attempts to enter a web-enabled data access point (alternate implementations may be configured as user identification verification modules—e.g., a user remote system logins instead of web-enabled access points). In step 345, the access/authentication point requests the login/verification module from the system. In turn, the system generates a login/verification module, which is returned to the access point in step 348. The access point executes the login/verification module in step 351. In the embodiment illustrated in FIG. 3B, nested security access is bolstered with an additional security element by transferring a login/verification module to the access point and executing the login/verification generation module locally. The system user enters access/authentication data in step 354, which is then transmitted to the NSA system in step 357. Upon receiving the access data, the NSA system conducts an authentication procedure in step 360. The NSA system then transmits an access data authenticity indicator to the access point. Based on the authenticity indicator, the access point facilitates/denies the system user to enter the access portal (or the user authentication request for an online transaction) in step 363.

In some implementations, the system may be configured to effectuate periodic, transactional or a number of other types of re-authentication 663 to ensure user authenticity beyond the initial authentication. For example, the system may be configured to re-request the access identifier that is associated with a media authentication application at certain intervals after the access point has cleared the initial authentication process 330-363. Furthermore, the system may be configured to request the access identifier as part of each communication or transaction between the access point and the system. In some implementations the request does not have to necessarily be transmitted with each communication, it may be transmitted with every fifth communication. In further implementations, the request may be transmitted at random intervals to ensure that the initially authenticated access point is still a viable access point.

Moreover, the re-authentication request may be configured to request data beyond the access identifier associated with the media initiated authentication application. The request may be configured to also re-request user identifying information 354 (e.g., user ID, password, PIN, token data or any other types of authentication data). The requests for user identifying information 354 and an access identifier 336 may be made as part of the same request or made independently. In an implementation, the request types may be alternated (or randomly) over a certain interval to ensure that both the media authentication application and the user identifying information remain independently viable beyond the initial authentication process.

FIG. 3C illustrates a flow diagram of a media initiated authentication process that is configured to facilitate encrypted transactions. In FIG. 3C, the system user initiates a transaction application in step 372. For example, transactions may be any number of processes that require additional security elements, such as conducting an online purchase, conducting online banking, operating an ATM machine, operating a portable device, and/or the like. In step 375, encryption data is generated and distributed to the system user's terminal 366, as well as a remote transaction facilitation server 369. On the system user's terminal, the transaction data is prepared along with token data 381. The token data may be generated as described above or in the alternative, the system user's terminal may send a request for a dynamically generated token in step 384. In step 387, the remote transaction server may be configured to generate and transmit a dynamic encrypted token. The system user's terminal may finalize the transaction data and transmit the full package in step 390 to a remote transaction server for processing and final authentication in step 393. The remote transaction server responds in step 396 with an Authentication Confirmation/Denial message that may be displayed to the system user in step 399.

FIG. 4 illustrates some aspects of the system associated with the generation of the nested secure access login module. The process starts with the access point creating and transmitting a login/verification request to the system in step 410 (described above). When the system receives the login/verification request, the system identifies the access point and the type of security provisions associated with the particular access point in step 420 (this type of data may be included in one or more system databases 110 from FIG. 1). For example, certain financial institutions may implement a multi-tiered data entry access point that requires designated user input selected for example from among elements including a username, a user's pin information, a user's password and/or token data. The system then creates a login/verification module that includes various instructions for creating the particular login/verification module and forwards the instructions to the access point in step 430. Examples instructions may facilitate the creation of dynamic access image generation (described below), text box element creation, and/or other resources utilized during the login/verification process.

After receiving the access login/verification module, the client executes the instructions transmitted by the system for constructing an access login/verification data entry form. For example, the module may include instructions for generating the modules illustrated in FIGS. 5A, 5B or a different access/verification data entry form depending on the particular implementation. Executing these instructions on the client provides a first layer of security for the nested security access procedure.

FIG. 5A illustrates an example of an access/verification data entry form wherein a customer's username and pin 510 are requested. These elements provide a second layer of security as they are selected by the customer and assumed to be known only by the customer. Another level of security is added to the NSA process with regard to password 520.

According to an implementation of the NSA system, the password element of the NSA modules includes at least two parts, the first is a dynamic password display image 520, 525 and the second relates to dynamic image selection input. As illustrated in FIG. 5A, the access/verification data entry form includes a password selection display 520, the displayed dynamic password images 525, and text data entry box 530. Another layer of security is provided specifically with regard to the generation and display of the displayed dynamic password images 525. More specifically the display image includes a series of alpha-numeric characters (although some embodiments may include symbols or combinations of symbols and characters) that are displayed to the system user. Accordingly, the system user selects the individual characters in a particular order to input the user-designated password.

In an implementation, the generation of each password component image 525 is displayed in a random sequence. Further, the number of images corresponding to non-password characters (i.e., in FIG. 5A the user's password is “dogs425”, so the non-password characters include 0, f, 7, 9, and Z) may vary depending on the implementation. It is to be understood that the values of the non-password characters may also be randomly generated. Alternately, an implementation generates the non-password characters in accordance with module instructions to include more numerals, than letters (or more letters, than numerals) based on the component make-up of the user-designated password.

The next level of security relates to the character images, themselves. In an embodiment of the invention characters 525 are individual images that are not necessarily correlated to text for entry in the text box 530. In this embodiment, the black circles are simply representative placeholders that assist a user in determining how many elements of the password have been selected.

In entering the password elements, the user may choose between manually typing the elements as in step 450 or simply selecting (e.g., clicking on) the images in the order of the user designated password as in step 455 (e.g., the user would click on the image for “d” followed by “o” and then “g” and so on . . . ) until the full password has been entered. Once the user designated password has been entered, the data is transmitted for verification in step 460.

FIG. 5B illustrates a similar embodiment of the access request data entry form, but also includes a token entry text box. Similar to the method for image selection, instead of typing the token elements into the text box 570, a token display image may be generated, wherein the system user selects various token elements from among a series of characters/symbols displayed to the user 560. In some implementations of the system, the system user's login module data may be encrypted before it is sent back to the system for authentication.

FIG. 5C-5J illustrate other examples of an access/verification data entry form wherein a customer's username 5100, PIN 5105, and a password or combination code are requested. Some implementations may also require a user to input token data in additional to username, PIN, and password information to further bolster secure access. In FIGS. 5C-5D, a virtual combination lock interface 575 is employed, allowing the user to specify a code by turning the combination lock knob to the appropriate number and clicking the “ADD” button 580 to populate a code field 590. This illustrative implementation is also equipped with a “CLEAR” button to clear the contents of the code field 590, as well as a “SUBMIT” button 595, to submit the entered code. Upon successful entry of the correct information, this implementation produces an open lock graphic 5110, an acceptance message 5115, and grants access to the user. In one embodiment, the pattern of knob turning is itself a component of the code, similar to the operation of many actual padlocks and/or combination locks. For example, the system may require the user to turn the knob one full turn counterclockwise, followed by the turning to the first number in a clockwise direction, the second number in a counterclockwise direction, and so forth.

In FIGS. 5E-5F, slider widgets 5120 are employed to allow the user to enter and submit 5125 a combination code. In FIGS. 5G-H, a widget similar to a briefcase combination lock 5130 is employed, wherein the user sets the code by turning a series of dials to achieve a particular configuration. This illustrative implementation is also equipped with a “RESET” button 5135 to bring the dials back to an initial position, and a “SUBMIT” button to submit the entry for consideration by the system.

In FIGS. 5I-5J, a collection of character and/or symbol tiles 5145 are displayed, allowing a user to select the appropriate tiles to complete their code and/or password. In this illustrative implementation, tiles may be dragged and dropped on a code field 5150, leaving behind empty spaces 5155 in the tile collection field. A completed code 5160 may then be submitted using a “SUBMIT” button 5165. In an alternative embodiment, the code field may be populated simply by clicking on the tiles rather than dragging and dropping them. In yet another embodiment, the tiles are rearranged into a proper order within their original location, rather than being moved to a separate code field.

In all of the interface examples discussed above, various numbers, letters, characters, punctuation marks, symbols, and/or the like may be employed in lieu of those shown within various implementations. Furthermore, the order and/or arrangement code elements may be modified as required by the particular implementation. For example, the combination lock in FIGS. 5C-5D may have a collection of pictorial symbols instead of numbers in one implementation.

FIG. 5K illustrates an example of the Login Access Denied message 5170 discussed above in the context of the flow diagram illustrated in FIG. 3B. Specifically, the message indicates that the system user should initiate media authentication. As discussed above, this may be accomplished any number of ways, such as inserting a disc; inserting a thumb drive; executing the media application on an internal hard drive, removable hard drive, wireless PDA or other portable device, or any other possible ways to execute an authentication program. After the media application has been initiated, the user login interface 5180 may be generated and displayed to the user as illustrated in FIG. 5L. Also, as described above the user interface may incorporate time-sensitive tokens. A token timer may conduct a numerical countdown or it may show a decreasing number of ‘timer bars’ 5185 in order to indicate that the tokens are time sensitive.

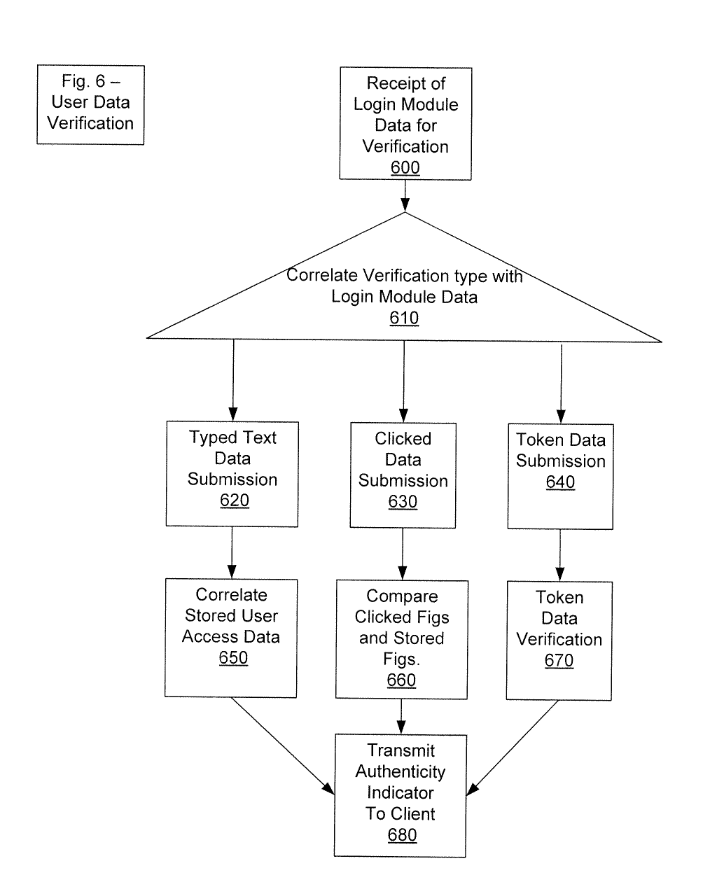

FIG. 6 illustrates an access/verification data authentication process associated with an embodiment of the NSA system. The system receives the login/verification module data for authentication in step 600. The first authentication step 610 involves determining what type of system user data has been submitted by the system user. For example, the system user may submit typed text password data 620, clicked password data 630 and/or token data submission 640. After the data type determination has been conducted, the system accesses system databases 110 (from FIG. 1) to execute the actual authentication of a system user submission that has been correlated stored user access/verification data 650. The system may effectuate authentication by comparing the sequence of selected figures, with the stored sequences of figures designated by the system user as a password 660; and/or conducting a token data verification 670, if necessary. Once the login module access/verification data has been authenticated, the NSA system 100 generates and transmits an authenticity indicator back to the access point in step 680. The authenticity indicator effectively indicates whether the system user should be allowed to proceed beyond the access point (or the user identification has been properly authenticated).

### Nested Security Access System Controller

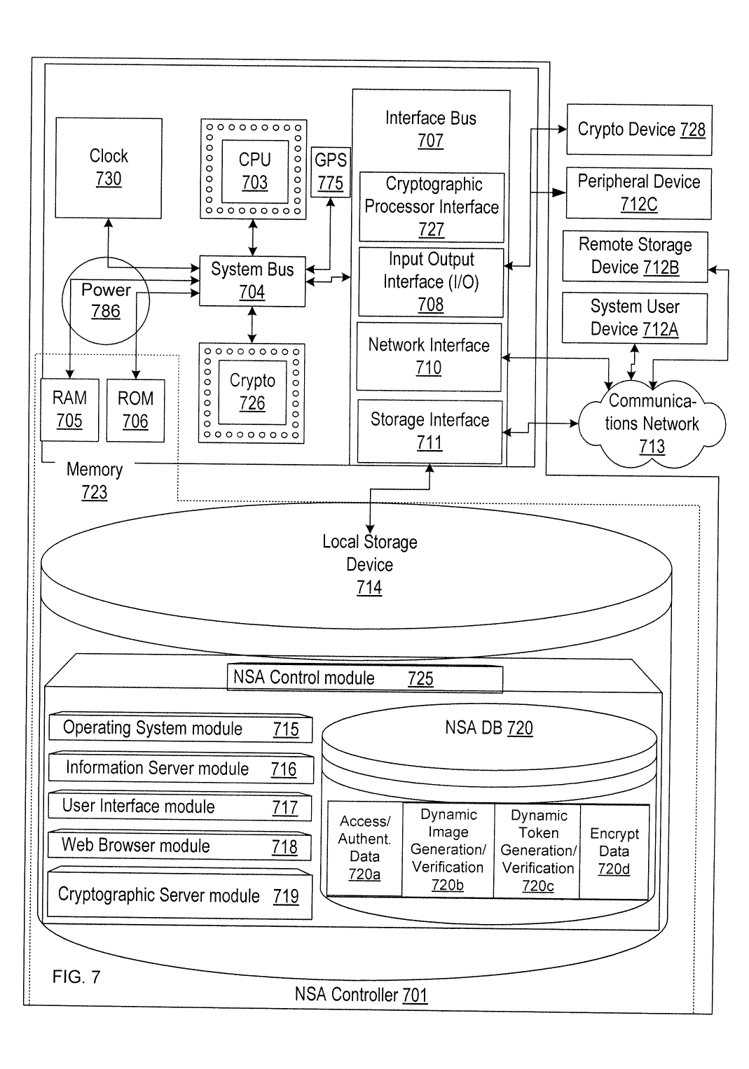

FIG. 7 of the present disclosure illustrates inventive aspects of a Nested Security Access (“NSA”) controller 701 in a block diagram. In this embodiment, the NSA controller 701 may serve to process, store, search, serve, identify, instruct, generate, match, and/or update job postings, job applications, and/or other related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the NSA controller 701 may be connected to and/or communicate with entities such as, but not limited to: one or more users from user input devices 712A; peripheral devices 712C; a cryptographic processor device 728; and/or a communications network 713.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The NSA controller 701 may be based on common computer systems that may comprise, but are not limited to, components such as: a computer systemization 702 connected to memory 723.

Computer Systemization

A computer systemization may comprise a clock 730, central processing unit (CPU) 703, a read only memory (ROM) 706, a random access memory (RAM) 705, and/or an interface bus 707, and most frequently, although not necessarily, are all interconnected and/or communicating through a system bus 704. Optionally, the computer systemization may be connected to an internal power source 786. Optionally, a cryptographic processor 726 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron and/or Opteron; IBM and/or Motorola's PowerPC; Intel's Celeron, Itanium, Pentium, Xeon, and/or XScale; and/or the like processor(s). The CPU interacts with memory through signal passing through conductive conduits to execute stored program code according to conventional data processing techniques. Such signal passing facilitates communication within the Nested Security Access controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 786 may be of any standard form for powering small electronic circuit board devices such as the following power cells: alkaline, lithium hydride, lithium ion, nickel cadmium, solar cells, and/or the like. Other types of AC or DC power sources may be used as well. In the case of solar cells, in one embodiment, the case provides an aperture through which the solar cell may capture photonic energy. The power cell 786 is connected to at least one of the interconnected subsequent components of the Nested Security Access thereby providing an electric current to all subsequent components. In one example, the power source 786 is connected to the system bus component 704. In an alternative embodiment, an outside power source 786 is provided through a connection across the I/O 708 interface. For example, a USB and/or IEEE 1394 connection carries both data and power across the connection and is therefore a suitable source of power.

Interface Adapters

Interface bus(ses) 707 may accept, connect, and/or communicate to a number of interface adapters, conventionally although not necessarily in the form of adapter cards, such as but not limited to: input output interfaces (I/O) 708, storage interfaces 711, network interfaces 710, and/or the like. Optionally, cryptographic processor interfaces 727 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 711 may accept, communicate, and/or connect to a number of storage devices such as, but not limited to: storage devices 714, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 710 may accept, communicate, and/or connect to a communications network 713. Through a communications network 713, the Nested Security Access controller is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 710 may be used to engage with various communications network types 713. For example, multiple network interfaces may be employed to allow for the communication over broadcast, multicast, and/or uni-cast networks.

Input Output interfaces (I/O) 708 may accept, communicate, and/or connect to user input devices 712A, peripheral devices 712C, cryptographic processor devices 728, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae S-Video, VGA, and/or the like; wireless; and/or the like. A common output device 712C is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 712A may be card readers, dongles, finger print readers, gloves, graphics tablets, joysticks, keyboards, mouse (mice), remote controls, retina readers, trackballs, trackpads, and/or the like.

Peripheral devices 712C may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the Nested Security Access controller may be embodied as an embedded, dedicated, and/or monitor-less (i.e., headless) device, wherein access would be provided over a network interface connection.

Cryptographic units such as, but not limited to, microcontrollers, processors 726, interfaces 727, and/or devices 728 may be attached, and/or communicate with the Nested Security Access controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 723. However, memory is a fungible technology and resource, thus, any number of memory embodiments may be employed in lieu of or in concert with one another. It is to be understood that the Nested Security Access controller and/or a computer systemization may employ various forms of memory 723. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 723 will include ROM 706, RAM 705, and a storage device 714. A storage device 714 may be any conventional computer system storage. Storage devices may include a drum; a (fixed and/or removable) magnetic disk drive; a magneto-optical drive; an optical drive (i.e., CD ROM/RAM/Recordable(CD-R), ReWritable (RW), DVD R/RW, etc.); and/or other devices of the like. Thus, a computer systemization generally requires and makes use of memory.

Module Collection

The memory 723 may contain a collection of program and/or database modules and/or data such as, but not limited to: operating system module(s) 715 (operating system); information server module(s) 716 (information server); user interface module(s) 717 (user interface); Web browser module(s) 718 (Web browser); NSA database(s) 720; cryptographic server module(s) 719 (cryptographic server); the Nested Security Access module(s) 725; and/or the like (i.e., collectively a module collection). These modules may be stored and accessed from the storage devices and/or from storage devices accessible through an interface bus. Although non-conventional software modules such as those in the module collection, typically, are stored in a local storage device 714, they may also be loaded and/or stored in memory such as: peripheral devices, RAM, remote storage facilities through a communications network, ROM, various forms of memory, and/or the like.

Operating System

The operating system module 715 is executable program code facilitating the operation of the Nested Security Access controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Palm OS, Windows 2000/2003/3.1/95/98/CE/Millenium/NT/XP (Server), and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the Nested Security Access controller to communicate with other entities through a communications network 713. Various communication protocols may be used by the Nested Security Access controller as a subcarrier transport mechanism for interaction, such as, but not limited to: multicast, TCP/IP, UDP, unicast, and/or the like.

Information Server

An information server module 716 is stored program code that is executed by the CPU. The information server may be a conventional Internet information server such as, but not limited to Apache Software Foundation's Apache, Microsoft's Internet Information Server, and/or the. The information server may allow for the execution of program modules through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on the Nested Security Access controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other modules in a module collection, including itself, and/or facilities of the like. Most frequently, the information server communicates with the Nested Security Access database 720 operating systems, other program modules, user interfaces, Web browsers, and/or the like.

Access to the Nested Security Access database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Nested Security Access controller. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Nested Security Access controller as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program module, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface module 717 is stored program code that is executed by the CPU. The user interface may be a conventional graphic user interface as provided by, with, and/or atop operating systems and/or operating environments such as Apple Macintosh OS, e.g., Aqua, Microsoft Windows (NT/XP), Unix X Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

Web Browser

A Web browser module 718 is stored program code that is executed by the CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScript, ActiveX, and/or the like. Web browsers and like information access tools may be integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Nested Security Access enabled nodes. The combined application may be nugatory on systems employing standard Web browsers.

Cryptographic Server

A cryptographic server module 719 is stored program code that is executed by the CPU 703, cryptographic processor 726, cryptographic processor interface 727, cryptographic processor device 728, and/or the like. Cryptographic processor interfaces will allow for expedition of encryption and/or decryption requests by the cryptographic module; however, the cryptographic module, alternatively, may run on a conventional CPU. The cryptographic module allows for the encryption and/or decryption of provided data. The cryptographic module allows for both symmetric and asymmetric (e.g., Pretty Good Protection (PGP)) encryption and/or decryption. The cryptographic module may employ cryptographic techniques such as, but not limited to: digital certificates (e.g., X.509 authentication framework), digital signatures, dual signatures, enveloping, password access protection, public key management, and/or the like. The cryptographic module will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Nested Security Access may encrypt all incoming and/or outgoing communications and may serve as node within a virtual private network (VPN) with a wider communications network. The cryptographic module facilitates the process of “security authorization” whereby access to a resource is inhibited by a security protocol wherein the cryptographic module effects authorized access to the secured resource. In addition, the cryptographic module may provide unique identifiers of content, e.g., employing and MD5 hash to obtain a unique signature for an digital audio file. A cryptographic module may communicate to and/or with other modules in a module collection, including itself, and/or facilities of the like. The cryptographic module supports encryption schemes allowing for the secure transmission of information across a communications network to enable the Nested Security Access module to engage in secure transactions if so desired. The cryptographic module facilitates the secure accessing of resources on the Nested Security Access controller and facilitates the access of secured resources on remote systems; i.e., it may act as a client and/or server of secured resources. Most frequently, the cryptographic module communicates with information servers, operating systems, other program modules, and/or the like. The cryptographic module may contain, communicate, generate, obtain, and/or provide program module, system, user, and/or data communications, requests, and/or responses.

The Nested Security Access Database

The Nested Security Access database module 720 may be embodied in a database and its stored data. The database is stored program code, which is executed by the CPU; the stored program code portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Nested Security Access database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the Nested Security Access database is implemented as a data-structure, the use of the Nested Security Access database 720 may be integrated into another module such as the Nested Security Access module 725. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the NSA database module 720 includes several tables 720a-d. An access/authentication table 720a includes fields related to authenticating user access and/or user identification data. A dynamic image generation/verification data table 720b includes data related to the generated the randomized password element information, as well as the verification processes. A dynamic token generation/verification table 720c includes fields that are used to both generate/verify the selected dynamic token data. An encryption data table 720d includes fields related to the encryption process. In one embodiment, the Nested Security Access database may interact with other database systems.

In one embodiment, user programs may contain various user interface primitives, which may serve to update the Nested Security Access system. Also, various accounts may require custom database tables depending upon the environments and the types of clients the Nested Security Access system may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database modules 720a-d. The nested security access controller may be configured to keep track of various settings, inputs, and parameters via database controllers.

The Nested Security Access database may communicate to and/or with other modules in a module collection, including itself, and/or facilities of the like. Most frequently, the Nested Security Access database communicates with the Nested Security Access module 725, other program modules, and/or the like. The database may contain, retain, and provide information regarding other nodes and data.

The Nested Security Access System

The Nested Security Access control module 725 is stored program code that is executed by the CPU. The Nested Security Access control module affects accessing, obtaining and the provision of information, services, transactions, and/or the like across various communications networks, as well as creating and facilitating the nested secure modules as discussed above.

The Nested Security Access module enables access of information between nodes may be developed by employing standard development tools such as, but not limited to: (ANSI) (Objective-) C (++), Apache modules, binary executables, database adapters, Java, JavaScript, mapping tools, procedural and object oriented development tools, PERL, Python, shell scripts, SQL commands, web application server extensions, WebObjects, and/or the like. In one embodiment, the Nested Security Access server employs a cryptographic server to encrypt and decrypt communications. The Nested Security Access module may communicate to and/or with other modules in a module collection, including itself, and/or facilities of the like. Most frequently, the Nested Security Access module communicates with the Nested Security Access database, operating systems, other program modules, and/or the like. The Nested Security Access system may contain, communicate, generate, obtain, and/or provide program module, system, user, and/or data communications, requests, and/or responses.

Distributed Nested Security Access

The structure and/or operation of any of the Nested Security Access node controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The configuration of the Nested Security Access controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A processor-implemented method for providing nested secure access comprising:
receiving an authentication request from a media initiated authentication request generated at an access point;
processing the authentication request to extract an access identifier that corresponds to an assigned identifier for the media authentication application that generated the media initiated authentication request;
generating a secure login module if an authentic access identifier is confirmed;
transmitting the secure login module to the access point;
receiving user identifying data that has been entered into an access point executed verification module;
authenticating the user identifying data; and
transmitting an authentication identifier to the access point.

2. The method of claim 1, further comprising:
extracting user ID, Password or PIN information from the received user identifying data.

3. The method of claim 2, wherein the user identifying data was entered as mouse click selections of displayed images.

4. The method of claim 3, wherein the displayed images were dynamically displayed as alpha-numeric or symbolic characters.

5. The method of claim 4, wherein alpha-numeric characters were generated by the secure login module.

6. The method of claim 2, wherein the user identifying data was entered as text data typed into a text entry form.

7. The method of claim 2, wherein the user identifying data includes dynamic token data.

8. The method of claim 1, further comprising:
transmitting an authentication indicator denying access in response to the media initiated authentication request.

9. The method of claim 8, wherein the authentication indicator denying access is generated when a discrepancy is detected between the extracted access identifier and an expected access identifier that has been associated to a media authentication application.

10. The method of claim 9, further comprising:
transmitting a request for proper media login initiation that includes the expected access identifier.

11. The method of claim 1, wherein the authentication indicator facilitates allowing access to the access point after the user identifying data has been verified as authentic.

12. The method of claim 1, further comprising:
receiving a request for an encrypted dynamic token from the access point.

13. The method of claim 12, further comprising:
processing a request for an encrypted dynamic token from the access point; and transmitting the generated encrypted dynamic token to the access point.

14. The method of claim 13, wherein the received user identifying data includes data associated with the generated encrypted dynamic token.

15. The method of claim 1, wherein user identifying data has been entered into the secure login module by through user interaction with an access widget that facilitates non-typed data entry.

16. The method of claim 1, further comprising:
transmitting a request for re-authentication to the access point.

17. The method of claim 16, wherein the re-authentication request requests access identifier and user-identifying data from an access point.

18. A processor-implemented method for providing nested security access, comprising:
initiating a media authentication application;
executing an initial authentication procedure;
receiving a session authentication request if the initial authentication procedure executes properly or denying access if the initial authentication procedure does not execute properly;
correlating the session authentication request to nested security modules;
creating a nested secure access generation module, wherein the nested secure access generation module includes components for facilitating a client-generated nested security module;
transmitting the nested secure access generation module to a client;
creating a session authentication record that processes received user verification data from a client and provides a session authentication indicator to the client.

19. The method of claim 16, wherein the session authentication indicator enables subsequent access to data held behind an access point.

20. The method of claim 16, wherein the session authentication indicator facilitates a subsequent online transaction.

21. A system for providing nested secure access comprising:
a memory;
a processor disposed in communication with said memory, and configured to issue a plurality of processing instructions stored in the memory, wherein the instructions issue signals to:
receive an authentication request from a media initiated authentication request generated at an access point;
process the authentication request to extract an access identifier that corresponds to an assigned identifier for the media authentication application that generated the media initiated authentication request;
generate a secure login module if an authentic access identifier is confirmed;
transmit the secure login module to the access point;
receive user identifying data that has been entered into an access point executed verification module;
authenticate the user identifying data; and
transmit an authentication identifier to the access point.

22. The system of claim 21, further comprising:
instructions issue signals to extract user ID, Password or PIN information from the received user identifying data.

23. The system of claim 22, wherein the user identifying data was entered as mouse click selections of displayed images.

24. The system of claim 23, wherein the displayed images were dynamically displayed as alpha-numeric or symbolic characters.

25. The system of claim 24, wherein alpha-numeric characters were generated by the secure login module.

26. The system of claim 22, wherein the user identifying data was entered as text data typed into a text entry form.

27. The system of claim 22, wherein the user identifying data includes dynamic token data.

28. The system of claim 21, further comprising:
instructions to transmit an authentication indicator denying access in response to the media initiated authentication request.

29. The system of claim 28, wherein the authentication indicator denying access is generated when a discrepancy is detected between the extracted access identifier and an expected access identifier that has been associated to a media authentication application.

30. The system of claim 29, further comprising:
instructions to transmit a request for proper media login initiation that includes the expected access identifier.

31. The system of claim 21, wherein the authentication indicator facilitates allowing access to the access point after the user identifying data has been verified as authentic.

32. The system of claim 21, further comprising:
instructions to receive a request for an encrypted dynamic token from the access point.

33. The system of claim 32, further comprising:
instructions to process a request for an encrypted dynamic token from the access point; and
transmit the generated encrypted dynamic token to the access point.

34. The system of claim 33, wherein the received user identifying data includes data associated with the generated encrypted dynamic token.

35. The system of claim 21, wherein user identifying data has been entered into the secure login module by through user interaction with an access widget that facilitates non-typed data entry.

36. The system of claim 21, further comprising:
instructions to transmit a request for re-authentication to the access point.

37. The system of claim 26, wherein the re-authentication request requests access identifier and user-identifying data from an access point.

38. A system for providing nested security access, comprising:
a memory;
a processor disposed in communication with said memory, and configured to issue a plurality of processing instructions stored in the memory, wherein the instructions issue signals to:
initiate a media authentication application;
execute an initial authentication procedure;
receive a session authentication request if the initial authentication procedure executes properly or denying access if the initial authentication procedure does not execute properly;
correlate the session authentication request to nested security modules;
creating a nested secure access generation module, wherein the nested secure access generation module includes components for facilitating a client-generated nested security module;
transmit the nested secure access generation module to a client; and
create a session authentication record that processes received user verification data from a client and provides a session authentication indicator to the client.

39. The system of claim 38, wherein the session authentication indicator enables subsequent access to data held behind an access point.

40. The system of claim 38, wherein the session authentication indicator enables an online transaction.
